(19) United States
(12) Patent Application Publication
(10) Pub. No.: US 2023/0283193 A1
(43) Pub. Date: Sep. 7, 2023

(54) METHOD OF CONTROLLING A SWITCHING CONVERTER AND RELATED INDUCTION COOKTOP

(71) Applicant: WHIRLPOOL CORPORATION, BENTON HARBOR, MI (US)

(72) Inventors: Salvatore Baldo, Grotte (AG) (IT); Andrea Gallivanoni, Casorate Sempione (IT); Cristiano Vito Pastore, Comerio (IT); Andrea Zoppi, Turano Lodigiano(LO) (IT)

(73) Assignee: WHIRLPOOL CORPORATION, BENTON HARBOR, MI (US)

(21) Appl. No.: 18/116,015

(22) Filed: Mar. 1, 2023

(30) Foreign Application Priority Data
Mar. 2, 2022 (EP) 22159840.2

(51) Int. Cl. H02M 7/04; H02M 7/219; H02M 1/00; H05B 6/12

(52) U.S. Cl. CPC H02M 7/05; H02M 7/219; H02M 1/0058; H05B 6/1236

(57) ABSTRACT

A switching converter, such as for an induction cooktop, that can be operated to deliver a power level smaller than the minimum power level for having a soft-switching. Input AC terminals are disconnected from the DC-bus capacitor to prevent it from being charged, so that the DC voltage exhibited by the DC-bus is null or smaller than a minimum nominal value when a next ON time interval T₁ begins. The switching converter helps prevent ticking noise.

### CROSS-REFERENCE TO RELATED APPLICATION

This application claims priority to European Patent Application No. 22159840.2, filed on 2 Mar. 2022, entitled “METHOD OF CONTROLLING A SWITCHING CONVERTER AND RELATED INDUCTION COOKTOP,” the disclosure of which is hereby incorporated herein by reference in its entirety.

### BACKGROUND OF THE DISCLOSURE

The present disclosure relates to voltage converters and more in particular to methods of controlling a switching converter usable for realizing induction cooktops and for induction heating items of cookware placed above a heating coil powered by the switching converter.

Some cooking appliances, in particular induction cooking appliances, have at least one main switching converter to supply induction heating elements with a supply voltage through actuation of a main energy supply. However, in some instances, (i) a ticking acoustic noise from the cookware is produced, and (ii) a suboptimal amount of dissipated power could be produced.

### SUMMARY

At least part of these drawbacks are overcome according to this disclosure by purposely not charging a direct current (DC)-bus capacitor during an OFF interval of the switching converter such that the DC-bus capacitor is substantially discharged when a new ON interval of the switching converter is started. For simplicity of language, this disclosure refers to a “DC-bus capacitor.” However, it should be understood that multiple DC-bus capacitors could be utilized instead of a single DC-bus capacitor.

According to an aspect, a switching converter of this disclosure may have a rectifier stage (Rect) comprising silicon controlled rectifiers (SCRs) and may have a control line that senses zero-crossing conditions of an alternating current (AC) input voltage and turns on the SCRs of the rectifying stage only when power is to be supplied to the load.

The present disclosure sets forth two technical advantages: (i) it eliminates the occurrences of the ticking noise, thus resulting in a more pleasing experience for the user; and (ii) it reduces the power dissipation on a controlled output switch S.

The disclosed methods may be used for controlling any kind of switching converters suitable for powering a heating coil of an induction cooktop and are not univocally destined for controlling quasi-resonant (QR) converters.

Switching converters adapted for induction cooktops and a related induction cooktop are also disclosed.

### BRIEF DESCRIPTION OF THE DRAWINGS

In the Drawings:

FIG. 1 is a basic circuit diagram of a QR converter powering a load connected to a rectifying stage through a controlled output switch;

FIG. 2 depicts a time graph of a control signal of the controlled output switch of the QR converter of FIG. 1 when the power to be supplied to the load is smaller than a minimum power value for having a soft switching;

FIG. 3 is a circuit diagram of a QR converter similar to that of FIG. 1 but with a controlled rectifier stage driven according to a method of this disclosure;

FIG. 4 is a circuit diagram of a QR converter with a control line that controls a SCR of the controlled rectifier stage according to a method of this disclosure;

FIG. 5 is a circuit diagram of a half-bridge switching converter with a controlled rectifier stage driven according to a method of this disclosure;

FIG. 6 is a circuit diagram of a half-bridge switching converter with a control line that controls a SCR of the controlled rectifier stage according to a method of this disclosure; and

FIG. 7 is a time graph of control signals for turning on SCRs of a rectifying stage, of the control pulses applied to the output switch for powering the load, and of the main signals of the switching converter of FIG. 4 during OFF phases and ON phases.

### DETAILED DESCRIPTION

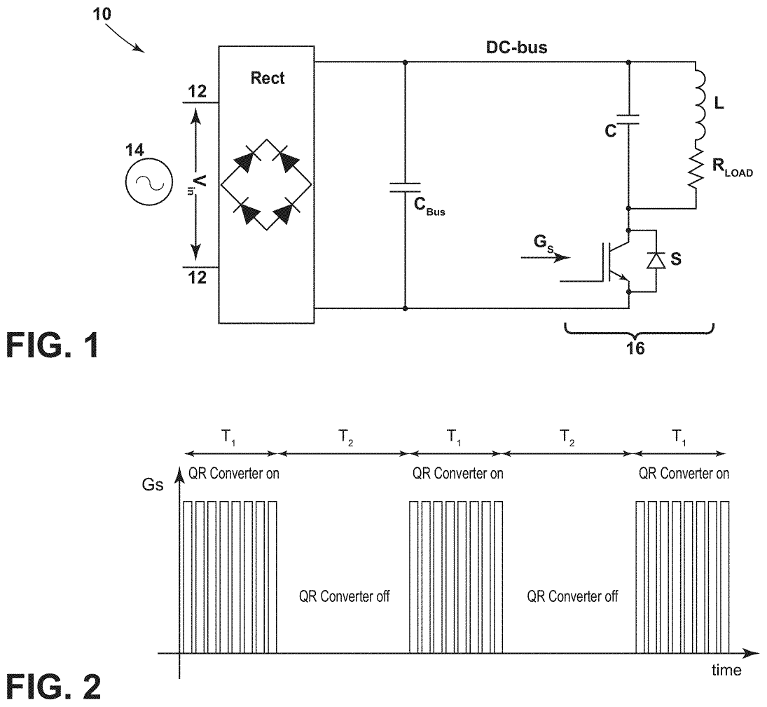

Referring to FIGS. 1 and 3-6, switching converters 10-10D can operate in a so called “soft-switching” mode, which includes having the switching converter 10-10D commutating when either the voltage across device S (or devices SH and SL) and/or the current flowing through device S (or devices SH and SL) are null. Half-bridge or full-bridge switching converters may be used. A particular class of switching converters is QR converters, also called Single Ended converters.

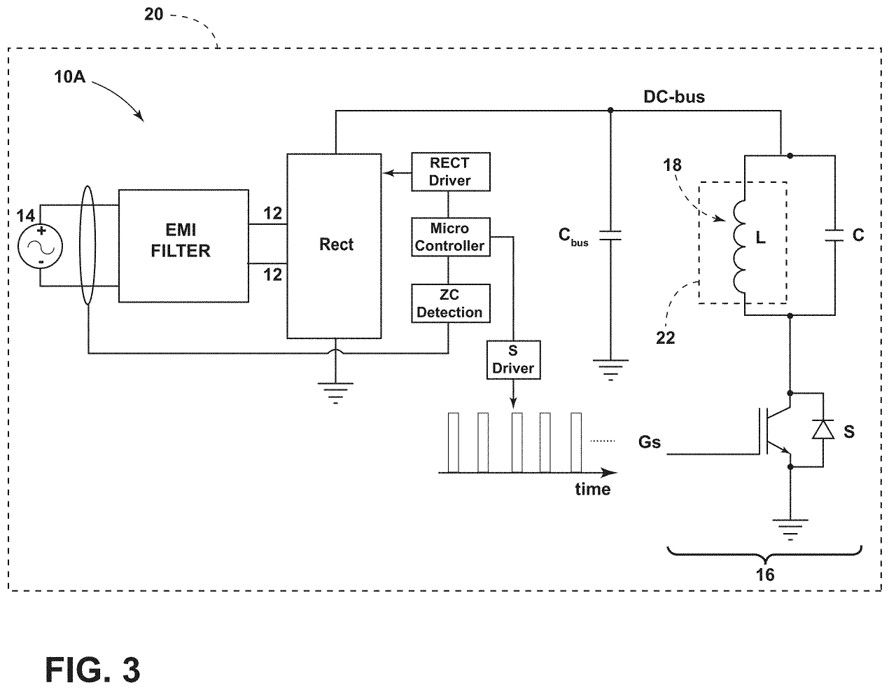

The switching converters 10 and 10A illustrated in FIGS. 1 and 3 each illustrate a QR converter. Basically, the QR converter comprises:

(A) a rectifier stage Rect having input AC terminals 12 for receiving an AC voltage 14 to be rectified, and a DC-bus having a high-side line for making available a DC voltage on the DC-bus between the high-side line and the low-side line, wherein the DC voltage is generated as a rectified replica of the AC voltage 14 received at the input AC terminals 12;

(B) an output stage 16 connected between the high-side line and the low-side line configured to be supplied with the DC voltage on the DC-bus, comprising:
a L-C resonant pair connected between the high-side line and an intermediate node, configured to be magnetically coupled with a load (R_{LOAD}). For example, the inductor L of the L-C resonant pair may be a heating coil 18 of an induction cooktop 20, and the capacitive component C of the resonant pair may be a capacitor dimensioned to determine a resonance frequency of the L-C resonant pair,
a DC bus capacitor connected between the high-side line and the low-side line; and
a controlled output switch S connected in series with the L-C resonant pair between the intermediate node and the low-side line; and
a control unit (not shown) configured to turn on/off the controlled output switch S.

The QR converter of FIG. 3 comprises an optional electromagnetic interference filter (EMI FILTER), in order to prevent electromagnetic interference from the QR converter 10.

Like the QR converters (e.g., switching converters 10 and 10A), other switching converters (e.g., switching converters 10B-10D) suitable for being used in induction cooktops 20 include the rectifier stage Rect, the output stage 16 with at least one inductor L (optionally the output stage 16 may include also a tank capacitor C connected to the inductor to form a L-C resonant pair), and at least one controlled output switch S connected between the intermediate node and either the low-side line or the high-side line, configured to connect or disconnect the inductor L to the DC-bus for being charged by the switching converter or for being discharged.

A drawback of this kind of converter lies in the range of output power being achievable in the Soft-Switching regime. In particular, when the output power being regulated falls below a given limit, the QR converter fails to operate in soft switching mode, leading to an increase in thermal losses (hard switching) and electromagnetic interference. Those limitations can limit the regulation range, which is defined as a ratio between maximum achievable power (limited by maximum voltage across the controlled output switch S) and the minimum achievable power (limited by the losses for hard switching at turn on). This situation can be an issue when the user wants to supply low power to cookware 22.

One mode for overcoming the aforementioned limitation for switching converters 10-10D is to operate the inverter in the so-called burst-mode or ON-OFF mode (as shown in FIG. 2), consisting in operating the switching converter 10-10D for some amount of time T1, during which several charging phases and discharging phases occur, at the minimum power level adjustable according to soft switching conditions, and switching it off for another amount of time T2. By cyclically alternating over time the two intervals, the average power delivered to the load can be calculated by multiplying the duty ratio T1/(T1+T2) by the minimum power limit (the minimum settable power to have soft switching).

For example, if a user wants to supply 100 W and the minimum power to have soft switching is 700 W, the system can operate in the above described ON/OFF mode, in which the bursts at 700 W are supplied for a short time interval T1, and for the remainder of the time interval T2 the switching converter is kept off, to obtain an average power delivery of 100 W. However, as alluded to above, this can cause the cookware 22 to produce the ticking noise, and the output switch S to dissipate power. For example, this can happen when the DC-bus capacitance is charged at the peak of the rectified mains line voltage (e.g., 325 V for nominal RMS line voltage of 230 V), and the controlled output switch S is turned on for the first time after a long period of being kept off. For example, if the switching converter is kept inactive for at least 10 ms, the first time it is turned on again after that period has elapsed this situation will occur. In those same conditions, there is also a large amount of power dissipation occurring in the output switch S, the so-called hard-switching condition. Obviously, this problem also occurs every time the output switch S is turned ON for the first time, after the main relay closure.

Another situation where ticking noise occurs is during the so-called “pan detection” operation, that is when the presence of cookware 22 on an induction heating cooktop is detected. The detection of the cookware 22 can be accomplished by feeding power to the induction heating coils and by assessing at least an electrical parameter of the QR converters of the induction heating cooktop 20 which is modified when the cookware 22 is placed on one or more induction coils. For example, a cookware 22 detection operation is to stimulate the induction coils with short PWM pulses and record the value of the electrical parameter of the converter. If the cookware 22 detection is operated when the DC-bus capacitor is charged, this could cause the noise to be produced.

Tests carried out by the Applicant have shown that the same drawback occurs also in induction cooktops 20 with different types of switching converters, other than QR converters. Therefore, it is believed that the above issues are not tied to the topology of QR converters but it affects any type of switching converter.

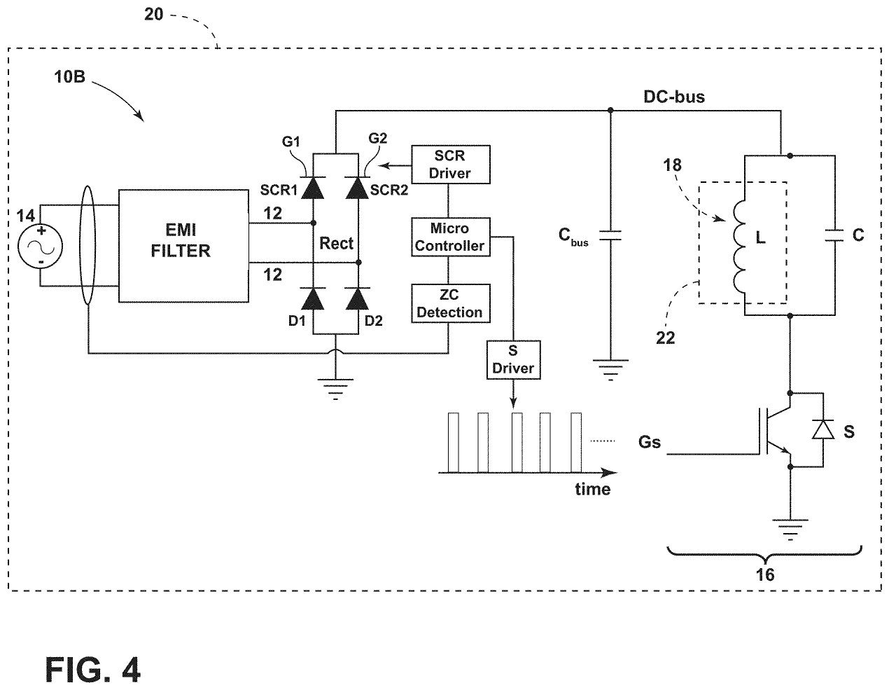

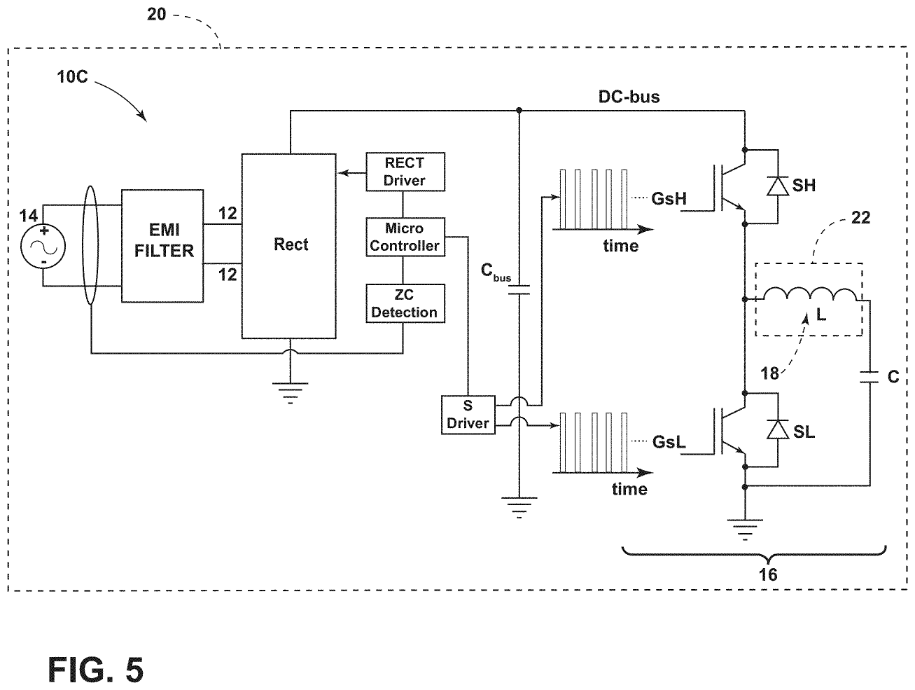

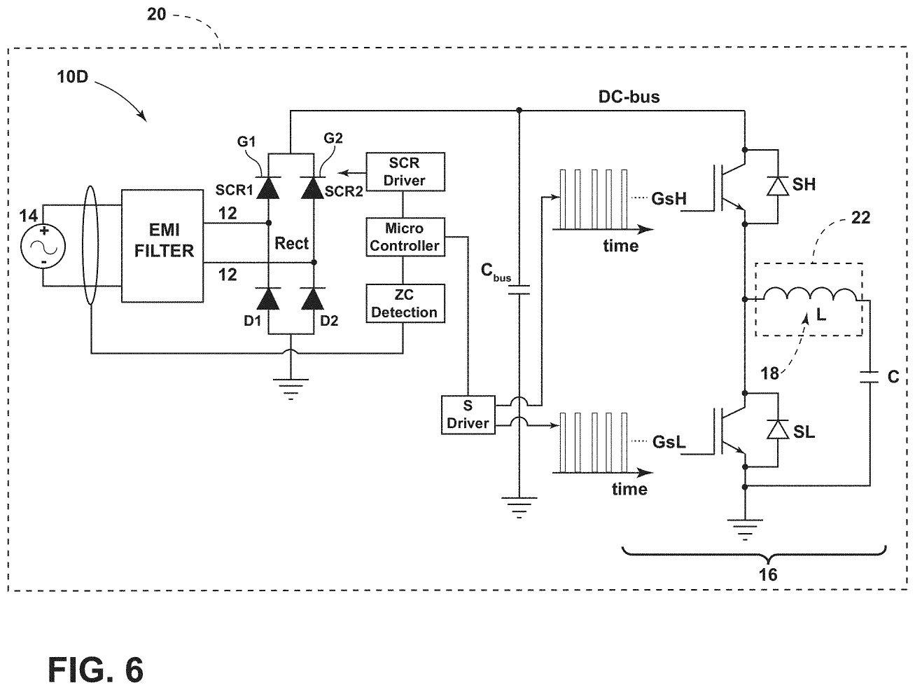

A switching converter 10-10D, that may be for example the QR converters depicted in FIGS. 3 and 4 (e.g., switching converters 10A, 10B), or the half-bridge switching converters of FIGS. 5 and 6 (e.g., switching converters 10C, 10D), or a full-bridge switching converter (not shown in the figures), may be controlled so as to prevent the generation of the ticking noise that can be heard when the switching converter 10 is operated to deliver a power level smaller than the minimum power level for having a soft-switching, or when a “cookware detection” operation is carried out before powering induction coil(s) surmounted by the cookware. This may be done by carrying out, before an ON time interval T1 of the switching converter 10 begins during which a load coupled with the inductor Lis powered by the switching converter 10, the step of operating ON/OFF the controlled rectifier stage Rect of the switching converter 10 so as to prevent the DC voltage on the capacitance (C_{Bus}) of the DC-bus between the high-side line and the low-side line from increasing during the OFF time intervals T2, in order to keep the DC voltage below a minimum nominal value, at which the above discussed drawbacks are practically negligible. By preventing the capacitance (C_{bus}) of the DC-bus from being charged during the OFF interval T2, the DC voltage is substantially null when the ON time interval T1 begins and thus a soft-switching, or a “low hard-switching” (i.e. a hard-switching with a relatively small voltage on the controlled output switch S of FIGS. 1, 3, and 4, or on the controlled high-side output switch SH of FIGS. 5 and 6) is performed because the voltage across the controlled output switch S (SH; SL) is at most equal to said minimum nominal value when the controlled output switch S (SH; SL) is turned on.

The switching converters 10A, 10C of FIGS. 3 and 5 have a controlled rectifier stage Rect configured to be switched in order to charge the DC-bus capacitor or to keep it disconnected from the supply line. Such a controlled rectifier stage Rect may be realized for example using a controlled half-bridge stage, or using a controlled full-bridge stage, or more generally using controlled switches configured to rectify the input voltage and connect/disconnect the DC-bus to the supply line on which the input voltage is made available. According to the present disclosure, when an ON time interval T1 of the switching converter 10A, 10C ends during which the load coupled with the inductor L is powered by the switching converter 10A, 10C, the controlled rectifier stage Rect is operated to disconnect from the input AC terminals the DC-bus capacitor and to prevent it from being charged, so as the DC voltage between the high-side line and the low-side line of the DC-bus is null or smaller than a minimum nominal value when the next ON time interval T1 begins.

In the shown embodiments, there is also an optional capacitor C connected to the inductor L in order to form a L-C resonant pair. In general, the capacitor C may be omitted in all those topologies of switching converters 10A, 10C that do not require a L-C resonant pair.

According to an aspect, the start of each ON time interval T1 is set to approximately coincide with the zero crossing of the mains line voltage, as detected by a zero-cross detection block ZC DETECTION. A microcontroller MICRO CONTROLLER, which controls also the driver S DRIVER of the controlled output switch S (or SH, SL), receives a zero-crossing signal from the ZC DETECTION block and commands a driver of the rectifier stage RECT DRIVER, which drives the controlled rectifier stage Rect in order to turn it on, so that the DC-bus capacitor is charged. When an OFF time interval T2 begins, the controlled rectifier stage RECT DRIVER is turned off by the driver RECT DRIVER in order to disconnect the DC-bus from the supply line, preventing the DC-bus capacitor from being charged and thus keeping null or negligible the DC voltage available thereon.

Preventing the capacitance of the DC-bus from being charged before powering the load is an efficient technique for avoiding the generation of the ticking noise when the switching converter 10-10D is operated by periodically alternating ON time intervals T1, during which the load coupled with the inductor L is powered by the switching converter 10-10D to OFF time intervals T2, during which the load is not powered by the switching converter 10-10D and the inductor L is left discharging. The ticking noise is typically generated when a switching converter is operated to deliver an average power smaller than the minimum power that can be delivered to the load while maintaining the controlled output switch S, SH, SL in soft-switching operation.

In these situations, shown for example in FIG. 2, during ON time intervals T1 the controlled output switch S, SH, SL is driven ON/OFF at a nominal switching frequency of the switching converter 10-10D and with a duty-cycle corresponding to said minimum power. During OFF time intervals T2 the controlled output switch S, SH, SL is kept OFF, wherein a duration of an ON time interval T1 and a duration of a subsequent OFF time interval T2 are adjusted such that an average power delivered to the load is a fraction of the minimum power.

According to an exemplary aspect of this disclosure, the switching converter 10B, 10D may be realized as shown in FIGS. 4 and 6, with:
a controlled rectifier stage Rect comprising a rectifying bridge containing at least two controlled switches (for example two SCRs SCR1, SCR2 controlled by respective gate trigger pulses G1, G2) disposed to rectify respectively, when activated, a positive and a negative half-wave of the AC voltage 14; and
a driver SCR DRIVER of the controlled switches SCR1, SCR2 of the rectifier stage Rect.

The other components are as in FIGS. 3 and 5 and have the same name.

Such a controlled rectifier stage Rect can be realized using controlled components such as, for example, SCRs, gate turn-off thyristors (GTOs), solid state transistors, relays, insulated gate bipolar transistors (IGBTs), and other components. Most advantageously, the controlled rectifier stage Rect is implemented using two solid state diodes and two SCRs, as shown in FIGS. 4 and 6.

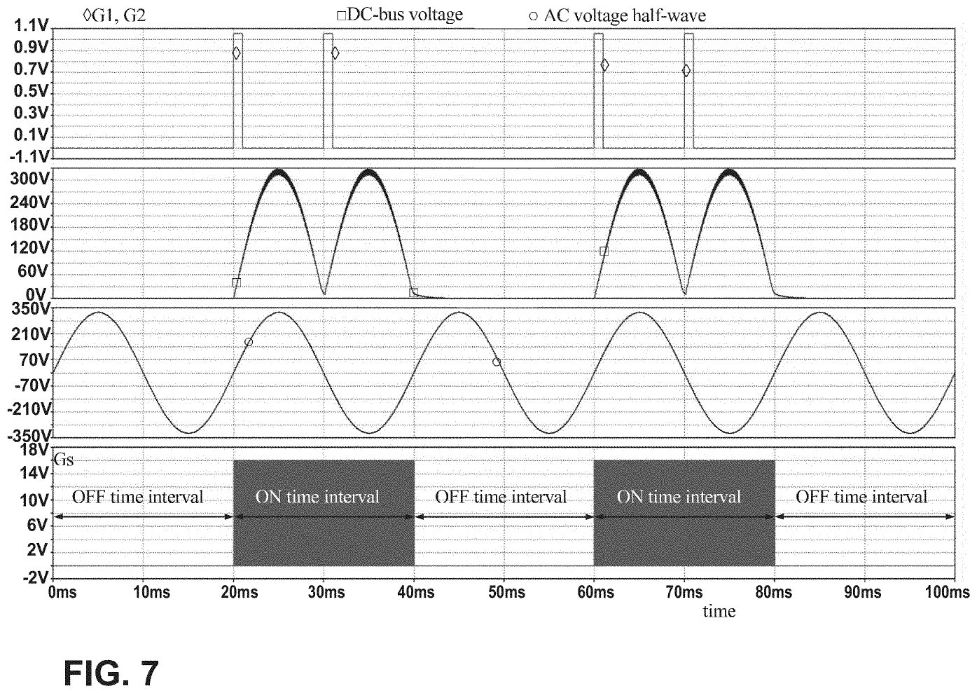

FIG. 7 shows an example of operation of the switching converters 10B, 10D depicted in FIGS. 4 and 6. In particular, FIG. 7 relates to a condition in which at the start of the shown operating phase the DC-bus capacitor is not charged, e.g., the voltage across the capacitance C-bus is null. In this condition, the micro controller (MICRO CONTROLLER) starts with an OFF time interval. During this time, the SCRs SCR1 and SCR2 are kept turned off, so that the DC-bus capacitor is not charged. As a result, at the end of the first OFF time interval shown, when an ON time interval begins, the DC-bus capacitor is not charged, and the controlled output switch S, SH, SL can be operated in a soft-switching condition.

The start of each ON time interval is set to approximately coincide with the zero crossing of the mains line AC voltage 14, as detected by the ZC DETECTION block. At this time, the system will activate the SCR DRIVER circuit in order to turn on the SCRs SCR1 and SCR2, so that the voltage rectifier Rect behaves as a traditional diode bridge rectifier, and the DC-bus is charged. This operation can be repeated for every zero-crossing event occurring during the ON time interval.

Due to the normal operation of the switching converter 10-10D, after the peak of the mains line AC voltage 14, the DC-bus capacitor will naturally be discharged, in a manner well known in the art, until the voltage across the capacitance Cbus of the DC-bus reaches almost zero in the vicinity of the subsequent zero crossing of the mains line AC voltage 14.

The beginning of each OFF time interval is also set to approximately coincide with the zero crossing of the mains line AC voltage 14, as detected by the ZC DETECTION block.

Starting from the beginning of an OFF time interval, and for the whole duration of said

OFF time interval, the SCRs of the rectifier stage Rect are kept off and thus the DC-bus capacitor cannot charge: when the subsequent ON time interval begins, the DC voltage on the DC-bus—and thus on the current terminals of the controlled output switch S, SH, SL—is practically null and a soft-switching or a “low hard-switching” is performed. This avoids charging the DC-bus capacitance C_{Bus} in the time intervals where the system does not intend to deliver power to the load (e.g., the cooking implement). In fact, what is described in this aspect of the present invention is not a method for discharging the DC-bus capacitance Cbus but it is a method for not charging it at all when not needed. However, this method cannot be used for silent cookware detection (because the energy of the cookware detection pulse is not enough to discharge the capacitance Cbus) but only at the beginning and during the power delivery. The rectifier stage in this case may be formed by two discrete low side diodes D1, D2 and two discrete high side controlled switches, for example the SCRs labeled SCR1, SCR2, that are turned on by the respective gate trigger signals G1, G2. Referring to the exemplary time graphs of FIG. 7, between 0 and 20 ms the DC-bus voltage is zero and there is no power delivery. At 20 ms the SCRs are turned on and simultaneously the power delivery starts (the signal Gs turns ON/OFF the controlled output switch S). For each half wave in which power delivery is requested, the SCRs will be turned on approximately in correspondence to the zero crossing. To terminate the power delivery, the PWM signal Gs is disabled at the end of the AC voltage 14 half-wave, when the DC-bus capacitance Cbus is completely discharged due to the normal operation of the converter during power delivery; it will be necessary to turn on again the SCRs to recharge the capacitance Cbus during the next power delivery phase.

The switching converters 10 presented above may be used to realize an induction cooktop 20, for heating an item of cookware 22, by using an induction heating coil as the inductive component L depicted in the FIGS. 3 to 6, configured to be magnetically coupled with the item of cookware 22 to be heated.

What is claimed is:

1. A method of controlling a switching converter, said switching converter comprising:
a controlled rectifier stage having input alternating current (AC) terminals, for receiving an AC voltage to be rectified, and a direct current (DC)-bus having a high-side line for making available a DC voltage on said DC-bus between the high-side line and said low-side line, the DC voltage being generated as a rectified replica of the AC voltage received at the input AC terminals;
an output stage connected between the high-side line and the low-side line configured to be supplied with the DC voltage on the DC-bus, comprising:
a DC bus capacitor connected between the high-side line and the low-side line;
at least one inductor connected at an intermediate node of the output stage, wherein the at least one inductor is configured to be magnetically coupled with a load, and
at least one controlled output switch connected between the intermediate node and either the low-side line or the high-side line, wherein the at least one controlled output switch is configured to connect or disconnect the at least one inductor to the DC-bus for charging the inductor by the switching converter or for discharging the inductor; and
a control unit configured to turn ON/OFF the at least one controlled output switch; the method comprising:
when an ON time interval of the switching converter ends, during which the load coupled with the at least one inductor is powered by the switching converter, operating the rectifier stage to disconnect from the input AC terminals the DC-bus between the high-side line and the low-side line to prevent the DC-bus from being charged, so that the DC voltage is null or smaller than a minimum nominal value when a next ON time interval begins.

2. The method of claim 1,
the controlled rectifier stage further comprising a rectifying bridge containing at least two controlled switches disposed to rectify respectively, when activated, a positive and a negative half-wave of the AC voltage;
the method further comprising:
sensing zero-crossings of the AC voltage and generating a respective zero-cross signal;
during the ON time interval, generating for each controlled switch of the at least two controlled switches a respective trigger pulse in function of the zero-crossings so as to generate the DC voltage as a rectified replica of the AC voltage; and
during the OFF time interval, keeping in an off state the at least two controlled switches.

3. The method of claim 1 further comprising:
periodically alternating ON time intervals of the switching converter, during which the load coupled with the at least one inductor is powered by the switching converter, to OFF time intervals of the switching converter, during which the load is not powered by the switching converter;
during said ON time intervals of the switching converter, driving ON/OFF the controlled output switch at a nominal switching frequency of the switching converter and with a duty-cycle corresponding to a minimum power to be delivered to the load by the switching converter to perform a soft-switching of the controlled output switch, wherein a duration of an ON time interval of the ON time intervals and a duration of a subsequent OFF time interval of the OFF time intervals are adjusted so as an average power delivered to the load is a fraction of the minimum power.

4. The method of claim 1, wherein the method is performed in operation of an induction cooktop.

5. A switching converter comprising:
a controlled rectifier stage comprising input AC terminals for receiving an AC voltage to be rectified, and a DC-bus having a high-side line for making available a DC voltage on the DC-bus between the high-side line and the low-side line, wherein the DC voltage is generated as a rectified replica of the AC voltage received at the input AC terminals;
an output stage connected between the high-side line and the low-side line configured to be supplied with the DC voltage on the DC-bus, the output stage comprising:
at least one inductor connected at an intermediate node, wherein the at least one inductor is configured to be magnetically coupled with a load,
a DC bus capacitor connected between the high-side line and the low-side line; and
at least one controlled output switch connected between the intermediate node and either the low-side line or the high-side line, wherein the at least one controlled output switch is configured to connect or disconnect the at least one inductor to the DC-bus for charging the inductor by the switching converter or for discharging the inductor; and
a control unit configured to turn ON/OFF the controlled output switch,
wherein the control unit is further configured, when an ON time interval of the switching converter ends during which a load coupled with the at least one inductor is powered by the switching converter, to operate the rectifier stage to disconnect from the input AC terminals the DC-bus between the high-side line and the low-side line to prevent the DC-bus from being charged, so that the DC voltage is null or smaller than a minimum nominal value when a next ON time interval begins.

6. The switching converter of claim 5, wherein
the controlled rectifier stage comprises a rectifying bridge comprising at least two controlled switches disposed to rectify respectively, when activated, a positive and a negative half-wave of the AC voltage;
the switching converter further comprises a zero-cross circuit block configured to sense zero-crossing of the AC voltage and to generate a respective zero-cross signal;
the control unit is further configured, during the ON time interval, to generate for each controlled switch of the two controlled switches a respective trigger pulse in function of the zero-cross signal in order to generate the DC voltage as a rectified replica of the AC voltage, and is configured, during said OFF time interval, to keep in an OFF state the at least two controlled switches.

7. The switching converter of claim 5, wherein
the switching converter is a quasi-resonant converter and the output stage further comprises a tank capacitor coupled with said at least one inductor to constitute a L-C resonant pair, and
the L-C resonant pair is connected between the high-side line and the intermediate node, and the controlled output switch is connected in series with said L-C resonant pair between the intermediate node and the low-side line.

8. The switching converter of claim 5, wherein
the output stage comprises:
a high-side controlled output switch connected between the high-side line and the intermediate node, and
a low-side controlled output switch connected between the intermediate node and the low-side line, and
the at least one inductor is connected between the low-side line and the intermediate node.

9. The switching converter of claim 8, wherein
the output stage further comprises a tank capacitor connected in series with the at least one inductor to constitute a L-C resonant pair, and
the L-C resonant pair is connected between the low-side line and the intermediate node.

10. The switching converter of claim 5, wherein
the switching converter is a component of an induction cooktop.

11. The switching converter of claim 6, wherein
the switching converter is a component of an induction cooktop.

12. The switching converter of claim 7, wherein
the switching converter is a component of an induction cooktop.

13. The switching converter of claim 8, wherein
the switching converter is a component of an induction cooktop.

14. An induction cooktop comprising:
a switching converter comprising (a) a controlled rectifier stage having input AC terminals for receiving an AC voltage to be rectified, a DC-bus for making available a DC voltage on the DC-bus that is a rectified replica of the AC voltage received at the input AC terminals, and a DC-bus capacitor, (b) an output stage configured to be supplied with the DC voltage on the DC-bus, wherein, the output stage comprises an inductor/capacitor resonant pair, (c) a controlled output switch connected in series with the inductor/capacitor resonant pair, and (d) a controller in communication with the controlled rectifier stage; and
a heating coil that is or comprising the inductor of the inductor/capacitor component resonant pair of the switching converter, the heating coil positioned to accept cookware as a load coupled with the heating coil for heating by the heating coil;
wherein, the controller is configured (i) to selectively activate the controlled rectifier state to connect the DC-bus to the AC terminals and deactivate the controlled rectifier stage to disconnect the DC-bus from the AC terminals and (ii) to selectively activate the controlled output switch to apply power to the cookware as the load during an ON time interval and deactivate the controlled output switch to not apply power to the cookware as the load during an OFF time interval.

15. The induction cooktop of claim 14, wherein
the induction cooktop does not generate an audible ticking noise either (i) when the switching converter is operated to deliver a level of power to the cookware as the load that is less than a minimal power level required to induce soft-switching or (ii) when a cookware detection operation is carried out to determine whether the cookware is positioned upon the heating coil.

16. The induction cooktop of claim 14, wherein
the controller is further configured to deactivate the controlled rectifier stage to disconnect the DC-bus from the AC terminals and prevent charging the capacitance of the DC-bus capacitor upon deactivating the controlled output switch to not apply power to the cookware as the load to begin an OFF time interval after an ON time interval.

17. The induction cooktop of claim 16, wherein
the DC-bus exhibits a substantially null DC voltage when the controller activates the controlled output switch to apply power to the cookware as the load to begin an ON time interval.

18. The induction cooktop of claim 16, wherein
the switching converter further comprises a zero-cross detection block configured to generate a zero-crossing signal as a function of zero-crossing of the AC-voltage,
the controller is further configured to activate the controlled output switch to apply power to the cookware as the load to begin an ON time interval as a function of receiving the zero-crossing signal, and
the controller is further configured to activate the controlled rectifier state to connect the DC-bus to the AC terminals as a function of receiving the zero-crossing signal.

19. The induction cooktop of claim 16, wherein
the controlled rectifying stage comprises a rectifying bridge comprising two controlled switches in communication with the controller, each of the two controlled switches configured to rectify a different one of a positive and a negative half-wave of the AC voltage.

20. The induction cooktop of claim 19, wherein
the switching converter further comprises a zero-cross detection block configured to generate a zero-crossing signal as a function of zero-crossing of the AC-voltage,
the two controlled switches are high side,
the controlled rectifying stage further comprises to low side diodes, and
for each half wave in which power delivery is requested, the controller is configured to activate the two controlled switches and the controlled output switch as a function of receiving the zero-crossing signal.
